(19) United States
(12) Patent Application Publication
(10) Pub. No.: US 2024/0413898 A1
(43) Pub. Date: Dec. 12, 2024

(54) RADIO RESOURCE MANAGEMENT FOR NON-TERRESTRIAL NETWORKS WITH MULTIPLE SYNCHRONIZATION SIGNAL BLOCK-BASED MEASUREMENT TIMING CONFIGURATIONS

(71) Applicant: APPLE INC., Cupertino, CA (US)

(72) Inventors: Jie Cui, San Jose, CA (US); Chunxuan Ye, San Diego, CA (US); Dawei Zhang, Saratoga, CA (US); Hong He, San Jose, CA (US); Huaning Niu, San Jose, CA (US); Manasa Raghavan, Sunnyvale, CA (US); Qiming Li, Beijing (CN); Sarma V. Vangala, Campbell, CA (US); Xiang Chen, Campbell, CA (US); Yang Tang, San Jose, CA (US)

(21) Appl. No.: 18/699,770

(22) PCT Filed: Oct. 22, 2021
(86) PCT No.: PCT/CN2021/125742

§ 371 Date: Apr. 9, 2024

(51) Int. Cl. H04B 7/185; H04B 7/19; H04B 7/195

(52) U.S. Cl. CPC H04B 7/18589; H04B 7/18539; H04B 7/19; H04B 7/195

(57) ABSTRACT

Systems and methods for the use of measurement object having multiple synchronization signal block (SSB)-based measurement timing configurations (SMTCs) indicating a same periodicity and different offsets are disclosed herein. In some of these cases, a wireless communications network can provide a user equipment (UE) with a measurement object (MO) having up to a total number of total SMTCs. or having SMTC sets each of up to a predetermined number of SMTCs. UE determinations regarding a number of the SMTCs to use to perform one or more corresponding SSB measurements during a period of a periodicity indicated by one or more SMTCs of an MO are also discussed. The use of scheduling restrictions by the UE based on non-terrestrial network (NTN) characteristics of one or more of a serving cell and a neighbor cell to be measured are also discussed.

### TECHNICAL FIELD

This application relates generally to wireless communication systems, including wireless communication systems using measurement objects (MOs) communicated between a network and a user equipment (UE) having one or more synchronization signal block (SSB)-based measurement timing configurations (SMTCs).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency band from 52.6 GHz to 71 GHz (or beyond). Bands in the millimeter wave (mm Wave) range of FR2 may have smaller coverage but potentially higher available bandwidth than bands in the FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a non-terrestrial network (NTN) architecture of a wireless communication system, according to an embodiment.

FIG. 2 illustrates an NTN architecture of a wireless communication system, according to an embodiment.

FIG. 3 illustrates a method of a UE, according to an embodiment.

FIG. 4 illustrates a method of a UE, according to an embodiment.

FIG. 5 illustrates a timeline showing the use of measurement windows as configured by SMTCs indicating a same periodicity that do not overlap during a period of the periodicity, according to an embodiment.

FIG. 6 illustrates a timeline showing the use of measurement windows as configured by SMTCs indicating a same periodicity that overlap during a period of the periodicity, according to an embodiment.

FIG. 7 illustrates a method of a UE, according to an embodiment.

FIG. 8 illustrates a method of a UE, according to an embodiment.

FIG. 9 illustrates an example architecture of a wireless communication system, according to embodiments disclosed herein.

FIG. 10 illustrates a system for performing signaling between a wireless device and a RAN device connected to a core network of a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

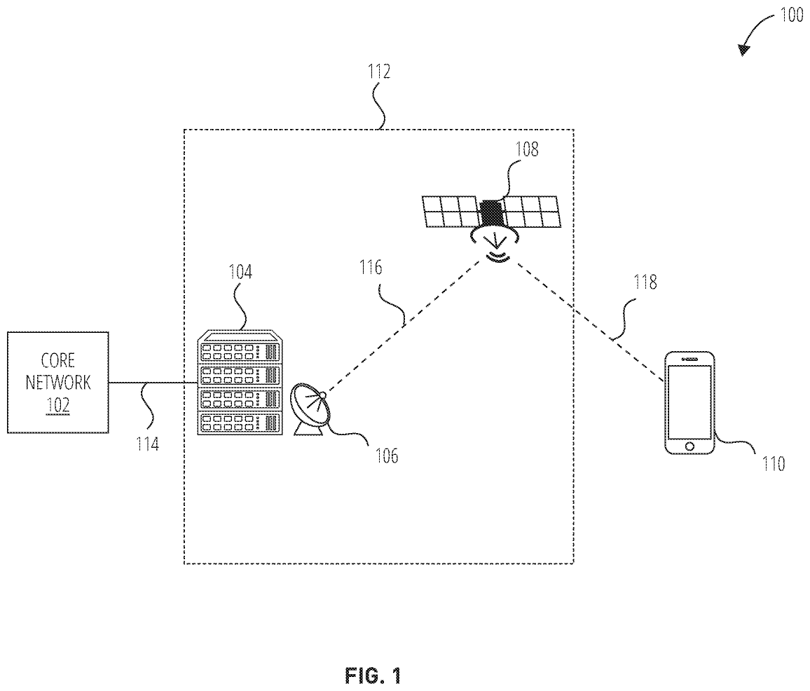

FIG. 1 illustrates a non-terrestrial network (NTN) architecture 100 of a wireless communication system, according to an embodiment. The NTN architecture 100 includes a core network (CN) 102, a terrestrial base station 104, a satellite gateway 106, a satellite 108, and a UE 110. The terrestrial base station 104, the satellite gateway 106, and the satellite 108 may be included in a RAN 112.

In some embodiments, the RAN 112 includes E-UTRAN, the CN 102 includes an EPC, and the terrestrial base station 104 includes an eNB. In these cases, the CN link 114 connecting the CN 102 and the terrestrial base station 104 may include an S1 interface.

In some embodiments, RAN 112 includes NG-RAN, the CN 102 includes a 5GC, and the terrestrial base station 104 includes a gNB or a next generation eNB (ng-eNB). In such cases, the CN link 114 connecting the CN 102 and the terrestrial base station 104 may include an NG interface.

The NTN architecture 100 illustrates a “bent-pipe” or “transparent” satellite based architecture. In such bent-pipe systems, the terrestrial base station 104 uses the satellite gateway 106 to communicate with the satellite 108 over a feeder link 116. The satellite 108 may be equipped with one or more antennas capable of broadcasting a cell according to the RAN 112, and the UE 110 may be equipped with one or more antennas (e.g., a moving parabolic antenna, an omni-directional phased-array antenna, etc.) capable of communicating with the satellite 108 via a Uu interface on that cell (such communications may be said to use the illustrated service link 118). A payload sited on the satellite 108 then transparently forwards data between the satellite gateway 106 and the UE 110 using the feeder link 116 between the satellite gateway 106 and the satellite 108 and the service link 118 between the satellite 108 and the UE 110. The payload may perform RF conversion and/or amplification in both uplink (UL) and downlink (DL) to enable this communication.

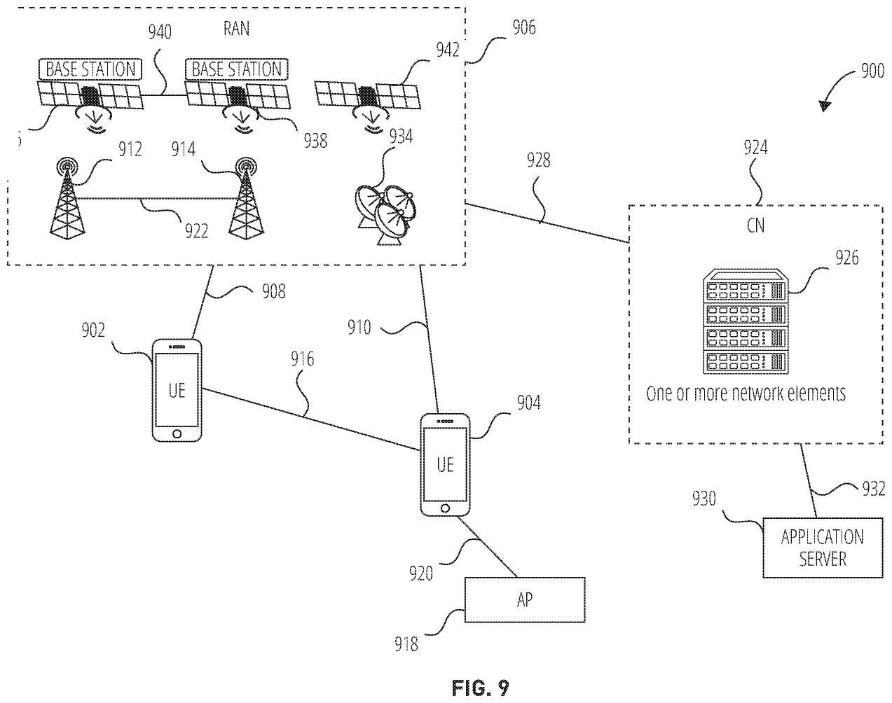

In the embodiment shown in FIG. 1, the terrestrial base station 104 is illustrated without the capability of terrestrial wireless communication directly with a UE. However, it is contemplated that in other embodiments, such a terrestrial base station using the satellite gateway 106 to communicate with the satellite 108 could (also) have this functionality (i.e., as in the terrestrial base station 912 and the terrestrial base station 914 of FIG. 9, to be described below).

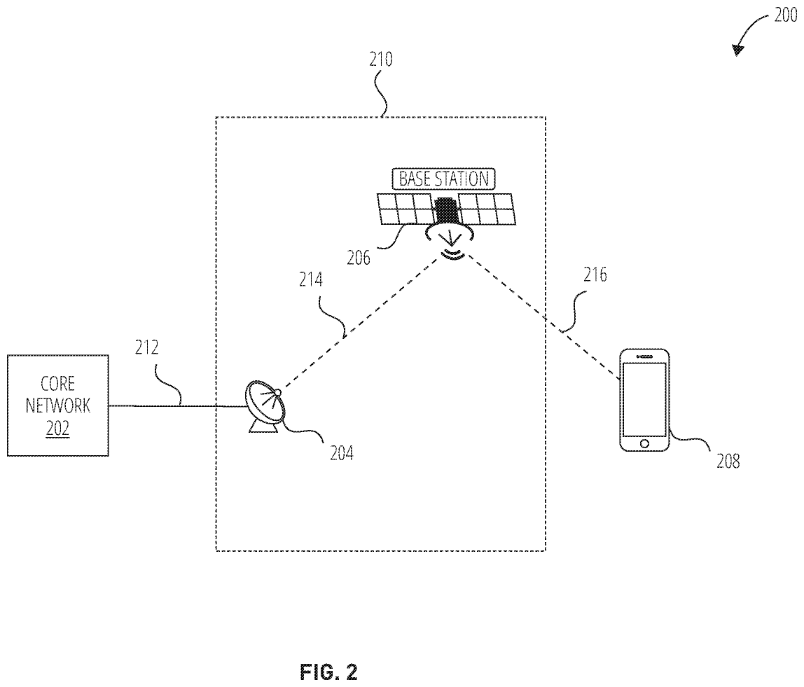

FIG. 2 illustrates an NTN architecture 200 of a wireless communication system, according to an embodiment. The NTN architecture 200 includes a CN 202, a satellite gateway 204, a satellite base station 206, and a UE 208. The satellite gateway 204 and the satellite base station 206 may be included in the RAN 210.

In some embodiments, the RAN 210 includes E-UTRAN and the CN 202 includes an EPC. In these cases, the CN link 212 connecting the CN 202 and the satellite gateway 204 may include an S1 interface.

In some embodiments, RAN 210 includes NG-RAN and the CN 202 includes a 5GC. In such cases, the CN link 212 connecting the CN 202 and the satellite gateway 204 may include an NG interface.

The NTN architecture 100 implements a “regenerative” satellite based architecture. In such regenerative systems, the functionalities of a base station are sited on the satellite base station 206, and the communications between these base station functions and the CN 202 occur through a forwarding of interface(s) (e.g., a S1 interface and/or an NG interface) found on the CN link 212 through the satellite gateway 204 and a feeder link 214 to the satellite base station 206. The satellite base station 206 may be equipped with one or more antennas capable of broadcasting a cell according to the RAN 210, and the UE 208 may be equipped with one or more antennas (e.g., a moving parabolic antenna, an omni-directional phased-array antenna, etc.) capable of communicating with the satellite base station 206 via a Uu interface on that cell (such communications may be said to use the illustrated service link 216). A payload sited on the satellite base station 206 then forwards data between the satellite gateway 204 and the UE 208 using the feeder link 214 between the satellite gateway 204 and the satellite base station 206 and the service link 216 between the satellite base station 206 and the UE 208. The payload may perform RF conversion and/or amplification in both uplink (UL) and downlink (DL) to enable this communication, as well as implement the functionalities of the base station (e.g., as an eNB, ng-eNB or a gNB, as corresponding to the type of the RAN 210) as these have been sited on the satellite base station 206.

In embodiments of NTN architectures comprising NG-RAN that also use integrated access and backhaul (IAB), it is possible that a gNB control unit functionality (CU) could be sited terrestrially and may use a satellite gateway to communicate with a satellite that hosts a corresponding gNB donor unit functionality (DU), with the F1 interface(s) between the CU and the DU underpinned by the feeder link 214. In such cases, the CU and the DU may each be understood to be part of the NG-RAN.

It may be that wireless communications systems using NTN architectures may use synchronization signal block (SSB)-based measurement timing configurations (SMTCs) to configure a UE to perform SSB measurements on a carrier (frequency) used by a set of cells broadcast by corresponding satellites of the wireless communication system. It may be that such an SMTC configurations may use a new scheme (e.g., incorporating a new use offsets) in order to account for various NTN aspects (as will be described). Further, it may be that measurement gaps corresponding to the SMTCs may be configured (as will be described).

Some satellites of some NTNs may be placed in a geosynchronous earth orbit (GEO) (sometimes also referred to as a geostationary earth orbit), which implies a placement at a specific radius relative to the earth. This radius is further out that many feasible distances for low earth orbits (LEOs) or medium earth orbits (MEOs), where a satellite could alternatively be placed. There may be more orbital capacity for satellite placement in these types of orbits as compared to the case of a GEO, and/or it may be cheaper to place a satellite in one of these types of orbits as compared to the case of a GEO. Accordingly, it is contemplated that a satellites of a wireless communication system may use a mixture of these possible orbit types (or some other type of orbit), and that this placement may be based on a balancing between, for example, cost, orbital capacity, and other factors. Herein, a cell that is broadcast by a satellite may be referred to as an “NTN cell.”

It is anticipated that NTN cells of the wireless communication system using a (same) given carrier may be broadcast by, for example, one or more of any of a satellite in GEO, a satellite in MEO, a satellite in LEO, or a satellite in some other type of orbit within the wireless communication system. As discussed above, the difference in radius from the earth as between as between these difference satellite orbit types may be significantly different. Accordingly, due to these different distances, synchronization signal blocks (SSBs) to be measured by the UE that are transmitted on these NTN cells may be ultimately received at the UE at different times (even despite any temporal synchronization between the various NTN cells as to the time of transmission). This may be different than the case of the UE receiving SSBs from multiple terrestrial transmission reception points (TRPs), where the differences in the UE distances from each relevant terrestrial TRP may be much smaller in magnitude (and thus corresponding signals may be received by the UE at (roughly) the same time).

In order to measure SSBs on a carrier, it may be that the UE is provided with a measurement object (MO) configuration that includes an indication of the carrier that is used by the satellites and a plurality of synchronization signal block (SSB)-based measurement timing configurations (SMTCs) for or corresponding to one or more SSBs on the carrier. This MO may further indicate a subcarrier spacing (SCS) used by that carrier.

Each of the plurality of SMTCs may indicate a periodicity and an offset (relative to a start of a period of the periodicity) at which the UE is to perform the SSB measurement (e.g., in the period). An SMTC may also include a duration of the SSB measurement.

In order to account for the different propagation times from different satellite orbit types, a first of these one or more SMTCs indicated in this MO may indicate a different offset than a second of the SMTCs for the carrier's MO. This may occur even in circumstances where a same periodicity is indicated in each of the first and second SMTCs. Accordingly, by using the different offsets, a UE may monitor for SSB sent from, for example, multiple satellites having different orbit types using the carrier. Further, in cases where the same periodicity is indicated in the SMTC having the differing offsets, these measurements are performed at the UE corresponding to a same periodicity scheme. This may be different than a case of, for example, MO for carriers for cells of terrestrial TRPs of the wireless communication system, where (substantially) different propagation times from different such terrestrial TRPs may not be a concern, and a single offset value is assumed to be able to capture all of the SSBs from all relevant terrestrial TRPs that are intended to be measured according to that periodicity.

In order to place an upper limit on the complexity of an MO for a carrier used by NTN cells and/or an upper limit on its signaling impact within the wireless communication system, it may be that limits on an amount of SMTCs in an MO for a carrier used by NTN cells may be established. For example, it may be that a maximum number of SMTCs provided by a single MO for a carrier used by NTN cells may be established. A another example, a maximum number of SMTCs provided in any organized set of SMTCs within a MO for a carrier used by NTN cells may be established. In some embodiments, this upper limit (in either type of case) may be four. Other values are contemplated. Such limits may apply for cases where the UE performs intra-frequency measurement on NTN cells.

In a first case, the wireless communication system may apply the upper limit as a total number of SMTC configurations provided in the MO for the carrier. In these cases, there may be a first SMTC set in the MO that contains one or more SMTC indicating a first periodicity. Further, there may be a second SMTC set in the MO that contains one or more SMTC indicating a second periodicity. It may be that each SMTC of an SMTC set uses an offset that is unique within that SMTC set. Further, it may be found that one or more SMTC of the first SMTC set and corresponding one or more SMTC of the second SMTC set indicate the same offset(s), but this is not required.

In such cases, it may be that that the total number of SMTC allowed by the network in the MO may be, for example, four. In such a case, it may be that the first SMTC set has two SMTCs and that the second SMTC set has two SMTCs. Alternatively, it may be that the first SMTC set has one SMTC and that the second SMTC set has three SMTCs. Further, it may be that in such cases, the upper limit is not necessarily reached, such that less than the maximum number of SMTCs are used (e.g., in the example of a maximum limit of four, it may be that the first SMTC set has one SMTC and that the second SMTC set has one or two SMTCs).

In a second case, the wireless communication system may apply the upper limit as a total number of SMTC configurations per SMTC set found in the MO for the carrier. In these cases, there may be a first SMTC set in the MO that contains one or more SMTC indicating a first periodicity. Further, there may be a second SMTC set in the MO that contains one or more SMTC indicating a second periodicity. It may be each SMTC of these SMTC sets uses an offset that is unique within that SMTC set. Further, it may be found that one or more SMTC of the first SMTC set and corresponding one or more SMTC of the second SMTC set indicate the same offset, but this is not required.

In such cases, it may be that that the total number of SMTC allowed by the network in each SMTC set of the MO may be, for example, four. In such a case, it may be that the first SMTC set has four SMTCs and that the second SMTC set has four SMTCs. Further, it may be that in such cases, the upper limit is not necessarily reached, such that less than the maximum number of SMTCs are used in one or more SMTC sets (e.g., in the example of a maximum limit of four, it may be that the first SMTC set has four SMTCs and that the second SMTC set has two or three SMTCs). Other combinations are contemplated.

In a third case, the wireless communication system may apply the upper limit as a total number of SMTC configurations provided in the MO for the carrier. In these cases, there may be no formal SMTC sets corresponding to SMTC indicating the same periodicity. It may further be that each SMTC may indicate a different periodicity than one, some, or all of the other SMTCs and/or a different periodicity than one, some, or all of the other SMTCs. It may be that in some cases, the number of possible periodicities indicated by these SMTC may be limited to (up to) a number that is analytically compatible/consistent with, for example, MO that are used for carriers used by terrestrial TRPs within the wireless communication system. For example, the upper limit may be two to match the use of MO for carriers of terrestrial TRPs that use up to two SMTC configurations.

In a fourth case, the wireless communication system may apply the upper limit as a total number of SMTC configurations provided in the MO for the carrier, where the MO uses a single SMTC set. Accordingly, there may be (up to) the upper limit of these SMTCs in the single SMTC set. The SMTCs of the single SMTC set may each indicate a single (same) periodicity. In such cases, there may be a single information element corresponding to the single SMTC set in the MO, and no second information element for any second SMTC set in that same MO.

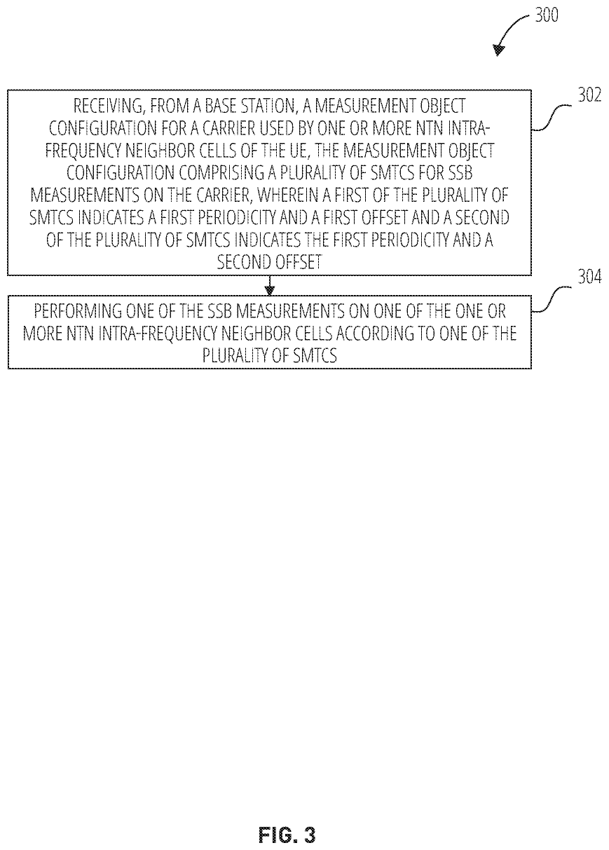

FIG. 3 illustrates a method 300 of a UE, according to an embodiment. The method 300 includes receiving 302, from a base station, a measurement object configuration for a carrier used by one or more NTN intra-frequency neighbor cells of the UE, the measurement object configuration comprising a plurality of SMTCs for SSB measurements on the carrier, wherein a first of the plurality of SMTCs indicates a first periodicity and a first offset and a second of the plurality of SMTCs indicates the first periodicity and a second offset.

The method 300 further includes performing 304 one of the SSB measurements on one of the one or more NTN intra-frequency neighbor cells according to one of the plurality of SMTCs.

In some embodiments of the method 300, the plurality of SMTCs are represented in the measurement object using a first SMTC set and a second SMTC set, wherein the first SMTC set comprises first one or more SMTCs of the plurality of SMTCs indicating the first periodicity, and wherein the second SMTC set comprises second one or more SMTCs of the plurality of SMTCs indicating a second periodicity. In some of these embodiments, each of the first one or more SMTCs indicates for a use of a unique offset as among the first one or more SMTCs. In some of these embodiments, a number of the first one or more SMTCs in the first SMTC set is limited by a first upper bound. In further embodiments where a number of the first one or more SMTCs in the first SMTC set is limited by a first upper bound, a number of second one or more SMTCs in the second SMTC set is limited by a second upper bound.

In some embodiments of the method 300, the measurement object configuration comprises a single SMTC set including the plurality of SMTCs, and wherein each of the plurality of SMTCs indicates a same periodicity.

Embodiments contemplated herein include an apparatus comprising means to perform one or more elements of the method 300. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 300. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a UE (such as a wireless device 1002 that is a UE, as described herein).

Embodiments contemplated herein include a signal as described in or related to one or more elements of the method 300.

Embodiments contemplated herein include a computer program or computer program product comprising instructions, wherein execution of the program by a processor is to cause the processor to carry out one or more elements of the method 300. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

In some cases, it may be that a UE that is configured to use NTN cells of a wireless communication system applies a scheduling restriction when it performs a measurement on one or more neighbor cells to its current serving cell. The UE may apply the scheduling restriction by not using its serving cell for either uplink (UL) transmission or downlink (DL) reception during a period corresponding to the measurement of the one or more neighbor cells. Such applications of a scheduling restriction may apply for cases where the UE performs either intra-frequency measurement or inter-frequency measurement on the one or more neighbor cells, and in the case that there is no measurement gap provided for at the UE for the measurement.

The use of such a scheduling restriction by a UE may be useful within wireless communication systems that use NTN cells because of the possibility of relative motion between the neighbor cell and the current serving cell of the UE. For example, a carrier of a first NTN cell may be perceived at the UE with a doppler shift due to the motion, relative to the UE, of its corresponding satellite (e.g., in the case that the NTN cell is provided by a LEO satellite). This doppler shift may cause the frequency of the cell to be imperfectly aligned relative to a frequency of a second cell as perceived by the UE. For example, this second cell may not be experiencing any doppler shift relative to the UE, in the case that it is broadcast by an GEO or a terrestrial TRP. Or, this second cell may (also) be an NTN cell that is perceived at the UE to have a different doppler shift, in the case that it is, for example, broadcast by an LEO that is moving in a different direction and/or speed than a satellite for the first cell. In either case, it may be that such a relative difference in doppler shift between the cells may make simultaneous use of the cells by the UE infeasible. Accordingly, the use of the scheduling restriction may be in anticipation of the possibility of such a relative difference in doppler shift between a serving cell of the UE and a neighbor cell of the UE that makes it infeasible to use both cells simultaneously.

As discussed above, the scheduling restriction may be applied to a period corresponding to the measurement. In the case that the UE measures an SSB of the neighbor cell (e.g., according to an SMTC for the carrier used by the neighbor cell, as described previously), this period may be a duration indicated by the SMTC for the SSB measurement. In the case that the UE measures some reference signal of the neighbor cell, this period may be the sum of a first duration of a first symbol prior to the reference signal measurement, a second duration corresponding to the reference signal measurement, and a third duration of a second symbol following the reference signal measurement. The use of the durations of the first and second symbols as described may provide a buffer that accounts for any timing mismatch between the serving cell and the cell to be measured, due to their (potentially) different propagation times due to (potentially) different distances from the UE (as described previously). For example, this buffer may be relevant in a case where a serving cell is broadcast by a GEO (and thus the timing at the UE corresponds to the reception timing of signals from this GEO), and the cell to be measured is broadcast by an LEO that is much closer to the UE.

A UE may determine one or more NTN characteristics of each of its serving cell and the neighbor cell to be measured. NTN characteristics determinable by the UE may include whether a cell is an NTN cell, or whether, for example, a cell broadcast by a terrestrial TRP instead. NTN characteristics determinable by the UE may also include, in the case of a cell that is an NTN cell, an orbit type of the satellite the broadcasts the NTN cell (e.g., whether the satellite is in LEO, MEO, GEO, etc.). NTN characteristics determinable by the UE may also include, for the case of a cell that is an NTN cell, a speed and/or a direction of the satellite that broadcasts the NTN cell.

In a first case, a UE may have support for mixed numerology. In a first alternative of such cases, it may be that the UE applies a scheduling restriction upon determining that either of the serving cell and/or the neighbor cell to be measured is an NTN cell.

In a second alternative of such cases, it may be that the UE applies a scheduling restriction upon determining that an orbit type of a satellite that provides the serving cell is different that an orbit type of satellite the provides the neighbor cell to be measured. For example, an orbit type for the satellite of the serving cell may be LEO, while an orbit type of the satellite of the neighbor cell to be measured may be GEO. Other differing orbit type combinations that would cause the UE to apply the scheduling restriction are contemplated.

In a third alternative of such cases, it may be that the UE applies a scheduling restriction upon determining that a speed and/or direction of a satellite that provides the serving cell is different than a speed and/or direction of a satellite that provides the neighbor cell to be measured. For example, the first satellite and the second satellite may be in the same orbit type (e.g., LEO). However, it may be that the UE determines to use the scheduling restriction after determining that the first satellite is moving in a first direction at a first speed, and the second satellite is moving in a second direction that is different than the first direction and/or a second speed that is different than the first speed.

In a second case, a UE may not have support for mixed numerology. In such cases, the scheduling restriction may be applied when the UE determines that a subcarrier spacing (SCS) used by the serving cell is different than an SCS used by the neighbor cell that is to be measured.

However, in cases where the UE does not support mixed numerology, but where the SCS of the serving cell and the SCS of the neighbor cell to be measured are the same, application (or not) of the scheduling restriction may be in response to a further determination by the UE. For example, the UE may apply a scheduling restriction upon determining that either of the serving cell and/or the neighbor cell to be measured is an NTN cell, as described above. Or, the UE may apply a scheduling restriction upon determining that an orbit type of a satellite that provides the serving cell is different that an orbit type of satellite the provides the neighbor cell to be measured, as described above. Or, the UE may apply a scheduling restriction upon determining that a speed and/or direction of a satellite that provides the serving cell is different than a speed and/or direction of a satellite that provides the neighbor cell to be measured, as described above.

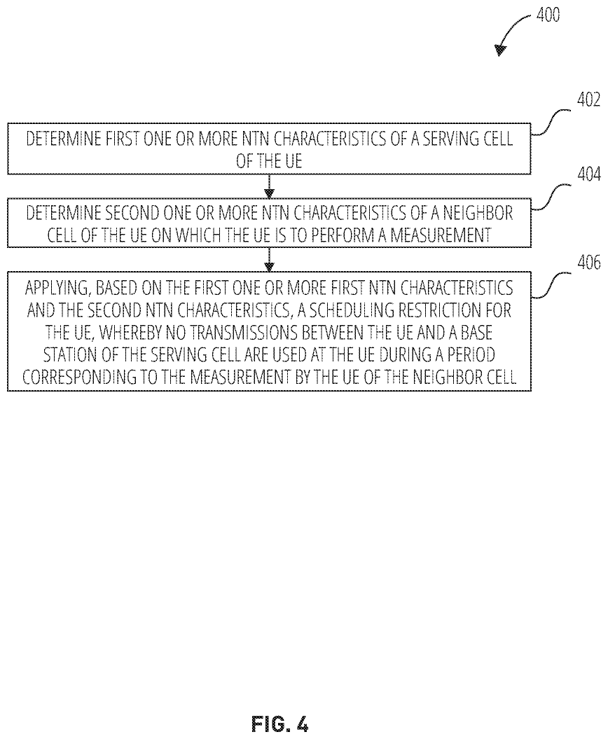

FIG. 4 illustrates a method 400 of a UE, according to an embodiment. The method 400 includes determining 402 first one or more NTN characteristics of a serving cell of the UE.

The method 400 further includes determining 404 second one or more NTN characteristics of a neighbor cell of the UE on which the UE is to perform a measurement.

The method 400 further includes applying 406, based on the first one or more first NTN characteristics and the second NTN characteristics, a scheduling restriction for the UE, whereby no transmissions between the UE and a base station of the serving cell are used at the UE during a period corresponding to the measurement by the UE of the neighbor cell.

In some embodiments of the method 400, the first one or more NTN characteristics of the serving cell include that the serving cell is an NTN cell, and the UE applies the scheduling restriction because the serving cell is an NTN cell.

In some embodiments of the method 400, the second one or more NTN characteristics of the neighbor cell include that the neighbor cell is an NTN cell, and the UE applies the scheduling restriction because the neighbor cell is an NTN cell.

In some embodiments of the method 400, the first one or more NTN characteristics of the serving cell comprise that the serving cell is provided by a first satellite that is in a first of a GEO and a LEO; the second one or more NTN characteristics of the neighbor cell comprise that the neighbor cell is provided by a second satellite that is in a second of the GEO and the LEO; and the UE applies the scheduling restriction based on a determination that the first satellite and the second satellite are in different types of orbits.

In some embodiments of the method 400, the first one or more NTN characteristics of the serving cell include that the serving cell is provided by a first satellite that is moving in a first direction at a first speed; the second one or more NTN characteristics of the neighbor cell include that the neighbor cell is provided by a second satellite that is moving in a second direction at a second speed; and the UE applies the scheduling restriction based on one or more of a first comparison of the first direction to the second direction and a second comparison of the first speed to the second speed. In some of these embodiments, the UE applies the scheduling restriction because the first direction is different than the second direction. In some of these embodiments, the UE applies the scheduling restriction because the first speed is different than the second speed.

In some embodiments of the method 400, the UE supports mixed numerology.

In some embodiments of the method 400, a first numerology of the serving cell is the same as a second numerology of the neighbor cell.

In some embodiments of the method 400, the measurement by the UE of the neighbor cell comprises an SSB measurement of the neighbor cell according to an SMTC at the UE corresponding to the neighbor cell, and wherein the period comprises a duration of the SSB measurement.

In some embodiments of the method 400, the measurement by the UE of the neighbor cell comprises a reference signal measurement of the neighbor cell, and wherein the period comprises a first duration of a first symbol prior to the reference signal measurement, a second duration corresponding to the reference signal measurement, and a third duration of a second symbol following the reference signal measurement.

In some embodiments of the method 400, the UE has not been configured with a measurement gap for the measurement.

Embodiments contemplated herein include an apparatus comprising means to perform one or more elements of the method 400. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 400. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a UE (such as a wireless device 1002 that is a UE, as described herein).

Embodiments contemplated herein include a signal as described in or related to one or more elements of the method 400.

Embodiments contemplated herein include a computer program or computer program product comprising instructions, wherein execution of the program by a processor is to cause the processor to carry out one or more elements of the method 400. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

In some cases, it may be that a UE that is configured to determine how many and/or which SMTC configurations as provided in a MO for a carrier used by one or more NTN neighbor cells that it will actually use to actually perform SSB measurement(s) on that carrier for those one or more NTN neighbor cells. The UE may make this determination as among SMTC of the MO that indicate for the same periodicity but for unique offsets. For example, a UE may receive (e.g., from a base station) a number X of SMTC configurations that each indicate a (same) given periodicity and a different offset. Then, the UE may determine a number Y of those SMTC configurations to actually use to measure SSB(s) on the corresponding carrier (where Y≤X) during a period of the periodicity. This determination may apply during one or more periods of the corresponding periodicity indicated by the relevant SMTCs (as will be shown). The Y SMTCs used during the same period of the periodicity may be described herein as “parallel SMTCs.”

Such determinations and their corresponding applications may apply for cases where the UE performs either intra-frequency measurement or inter-frequency measurement on a neighbor cell, when there is no measurement gap provided for at the UE for the measurement. Further, such determinations may apply when the carriers of the serving cell and/or the neighbor cells being measured are found in FR1.

This determination may turn on, among other things, whether the UE supports mixed numerology. In a first case, where the UE supports mixed numerology, the UE may be able to simultaneously use a first carrier on its serving cell while performing measurements on a second carrier of the one or more NTN neighbor cells, even in the case where the first carrier corresponds to a first SCS and the second carrier corresponds to a second (different) SCS. In such cases, the UE may determine to use all of the X SMTC configurations, such that Y=X

In other embodiments of this first case, it may be that the UE instead selects Y<X configurations to use.

In a second case, where the UE does not support mixed numerology, it may be that a UE may not be able to simultaneously use a first carrier on its serving cell while performing measurements on a second carrier of the one or more NTN neighbor cells (e.g., in the case where the first carrier corresponds to a first SCS and the second carrier corresponds to a second (different) SCS).

In a first embodiment of the second case, it may be that the selection of Y is bounded based on an interruption percentage that corresponds to one or more scheduling restrictions caused by the use of the Y SMTCs. For example, the UE may be configured to apply a scheduling restriction (e.g., pause any use of its serving cell) when the SSB measurements corresponding to each of a number SMTCs is performed. An interruption percentage corresponding to an amount of a period that is used for such scheduling restrictions may be determined and then compared to an interruption percentage threshold. If the interruption percentage is greater than the threshold, that number of SMTCs is too great (e.g., that number of SMTCs cannot be selected as Y). The UE may repeat this process until an appropriate value for Y is determined.

The interruption percentage threshold may be determined according to presumed characteristics of the SMTCs and/or other wireless communication system assumptions. For example, if the SMTCs indicate a periodicity of 20 ms, and a maximum SMTC window assumed by the wireless communication system is 5 ms, then an interruption percentage threshold may be set to 5 ms/20 ms, or 25 percent. Other mechanisms of setting this interruption threshold percentage may be used.

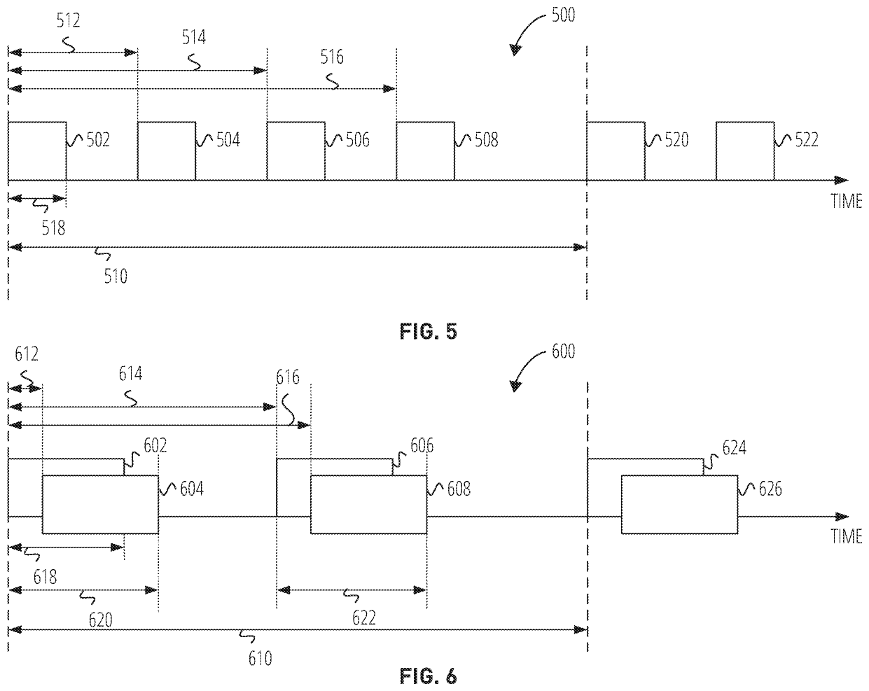

FIG. 5 illustrates a timeline 500 showing the use of measurement windows 502 through 508 as configured by SMTCs indicating a same periodicity that do not overlap during a period 510 of the periodicity, according to an embodiment. For example, the first measurement window 502 may be configured according to a first SMTC indicating the periodicity that indicates no offset. The second measurement window 504 may be configured according to a second SMTC indicating the periodicity that indicates the first offset 512. The third measurement window 506 may be configured according to a third SMTC indicating the periodicity that indicates the second offset 514. Finally, the fourth measurement window 508 may be configured according to a fourth SMTC indicating the periodicity that indicates the third offset 516.

Each of the measurement windows 502 through 508 may have a duration of the SMTC length 518. In the case that the SCS of the carrier of the serving cell and the SCS of the carrier of the MO having the SMTCs is different, the scheduling restriction is applied during each of the measurement windows 502 through 508. Then, an interruption length corresponding to each of the measurement windows 502 through 508 may be the SMTC length 518. The interruption percentage for the use of each of the SMTCs configuring for the measurement windows 502 through 508 may then be determined using:
numberOfSMTCs*interruption Length/periodicityIndicatedBySMTCs.

In the example of FIG. 5, this corresponds to multiplying four by the SMTC length 518, and then dividing the result by the periodicity. This value may then be compared to the interruption percentage threshold to ensure that the use of these (four) SMTCs will not result in a violation of this threshold, as described above.

Note that in the case that the SCS of the carrier of the serving cell and the SCS of the carrier of the MO having the SMTCs is the same, no scheduling restriction is applied during any of the measurement windows 502 through 508, and an interruption length corresponding to each of the measurement windows 502 through 508 may be zero. Accordingly, the interruption percentage will calculate to zero, and the interruption percentage threshold will not be surpassed.

Finally, note that the fifth measurement window 520 and the sixth measurement window 522 are not used in the above process relative to the period 510, because they do not fall within the period 510.

FIG. 6 illustrates a timeline 600 showing the use of measurement windows 602 through 608 as configured by SMTCs indicating a same periodicity that overlap during a period 610 of the periodicity, according to an embodiment. For example, the first measurement window 602 may be configured according to a first SMTC indicating the periodicity that indicates no offset. The second measurement window 604 may be configured according to a second SMTC indicating the periodicity that indicates the first offset 612. The third measurement window 606 may be configured according to a third SMTC indicating the periodicity that indicates the second offset 614. Finally, the fourth measurement window 608 may be configured according to a fourth SMTC indicating the periodicity that indicates the third offset 616.

In the case that the SCS of the carrier of the serving cell and the SCS of the carrier of the MO having the SMTCs is different, the scheduling restriction is applied during each of the measurement windows 602 through 608. Then, an interruption length corresponding to the measurement windows 602 through 608 may be based on SMTC length 618 of each of the measurement windows 602 through 608, as adjusted by overlap between any of the measurement windows 602 through 608.

For example, each of the measurement windows 602 through 608 may have a duration of the SMTC length 618. As illustrated, the first interruption length 620 may correspond to the portion of the period 610 that is covered by either the first measurement window 602 and/or the second measurement window 604 (which are overlapped). The UE may be able to determine the first interruption length 620 by using the SMTC length 618 and the first offset 612. Further, as illustrated, the second interruption length 622 may correspond to the portion of the period 610 that is covered by either the third measurement window 606 and/or the fourth measurement window 608 (which are overlapped). The UE may be able to determine the second interruption length 622 by using the SMTC length 618, the second offset 614, and the third offset 616.

The interruption percentage for the use of each of the SMTCs configuring for the measurement windows 602 through 608 may be determined using:
sumOfInterruption Lengths/periodicityIndicatedBySMTCs.

In the example of FIG. 6, this corresponds to summing the first interruption length 620 and the second interruption length 622, and then dividing the result by the periodicity. This value may then be compared to the interruption percentage threshold to ensure that the use of these (four) SMTCs will not result in a violation of this threshold.

Note that in the case that the SCS of the carrier of the serving cell and the SCS of the carrier of the MO having the SMTCs is the same, then interruption lengths corresponding the measurement windows 602 through 608 may be zero, because no scheduling restriction is applied during any of the measurement windows 602 through 608. Accordingly, the interruption percentage will calculate to zero, and the interruption percentage threshold will not be surpassed.

Finally, note that the fifth measurement window 624 and the sixth measurement window 626 are not used in the above process relative to the period 610, because they do not fall within the period 610.

In a second embodiment of the second case, it may be that the number Y is a hardcoded value (e.g., to the UE). In some of these cases, it may be that Y<X.

In a third embodiment of the second case, it may be that the UE selects a number Y that it then indicates to the network as a capability. In such cases, it may be that a value for Y is selected such that Y<X.

In a fourth embodiment of the second case, it may be that Y corresponds to a sharing percentage for SMTCs indicating the same periodicity. For example, in a case where there are four SMTCs indicating a same periodicity and a sharing percentage of 25%, it may be that Y=1 (as one is 25 percent of four). In some cases, a sharing percentage may be provided by a base station in the measurement object configuration. In some cases, the sharing percentage may be hardcoded to the UE

The manner of identifying the Y SMTCs (e.g., identifying the particular SMTCs that are deemed to each represent one of the Y SMTCs) from among the X SMTCs is now discussed.

In a first case, the UE may provide the network with the value of Y, Then, the network identifies the SMTCs that may then be used by the UE as the Y SMTCs. For example, in the case that the UE reports that Y=1, the network may indicate that a first SMTC is to be used during a first period of the periodicity, and a second SMTC is to be used during a second period of the periodicity, and so on. As another example, in a case where the UE reports Y=2, the network may indicate that a first and a second SMTC are to be used during a first period of the periodicity, and that a third and a fourth SMTC are to be used during a second period of the periodicity, and so on. This identification may be sent in one or more of radio resource control (RRC) signaling, medium access control (MAC) signaling (e.g., a MAC control element (MAC CE)), and/or in downlink control information (DCI).

In a second case, the UE identifies the Y SMTCs (e.g., without base station intervention) and send an indication of the identification of the Y SMTCs to the network. This identification may be sent in one or more of RRC signaling, MAC signaling (e.g., a MAC CE), and/or in uplink control information (UCI)

In a third case, the UE may identify the Y SMTCs according to a use of a sharing percentage (e.g., as described above) within a round robin scheme. For example, in a case where there are four SMTCs with a sharing percentage of 75%, three SMTCs may be used per period. Then, as part of the round robin scheme, it may be that in a first period, a first, second, and third of the four SMTCs may be used. In the next period, the second, third, and a fourth of the fourth SMTCs may be used. In the next period, the third, fourth, and first STMCs may be used (and so on). Other patterns according to a round robin scheme (and as adjusted for different sharing factors and/or number of SMTC indicating the periodicity) are contemplated.

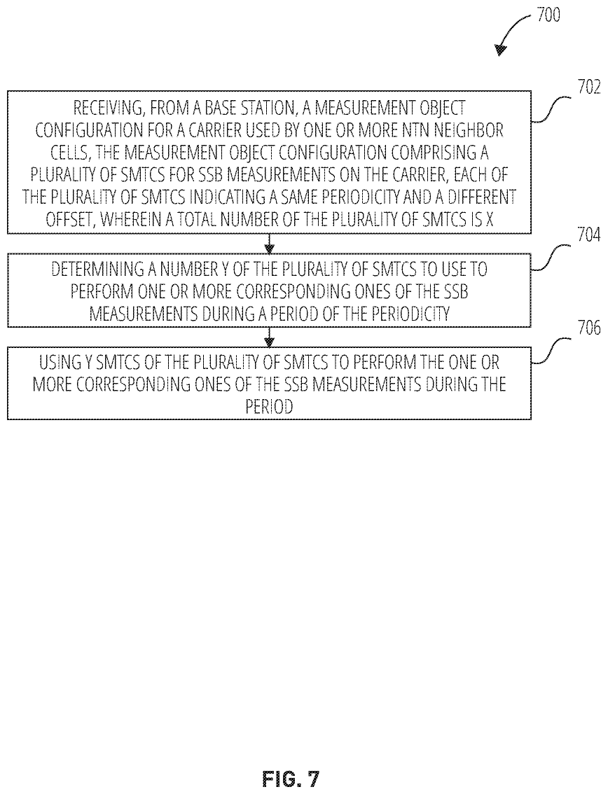

FIG. 7 illustrates a method 700 of a UE, according to an embodiment. The method 700 includes receiving 702, from a base station, a measurement object configuration for a carrier used by one or more NTN neighbor cells, the measurement object configuration comprising a plurality of SMTCs for SSB measurements on the carrier, each of the plurality of SMTCs indicating a same periodicity and a different offset, wherein a total number of the plurality of SMTCs is X.

The method 700 further includes determining 704 a number Y of the plurality of SMTCs to use to perform one or more corresponding ones of the SSB measurements during a period of the periodicity.

The method 700 further includes using 706 Y SMTCs of the plurality of SMTCs to perform the one or more corresponding ones of the SSB measurements during the period.

In some embodiments of the method 700, the UE supports mixed numerology. In some such embodiments, Y=X. In some such embodiments, Y<X.

In some embodiments of the method 700, the UE does not support mixed numerology. In some such embodiments, Y is bounded based on an interruption percentage corresponding one or more scheduling restrictions caused by the use of the Y SMTCs. In some such embodiments, Y is a hardcoded value, with Y<X. In some such embodiments, the method 700 further includes selecting Y such that Y<X; and indicating Y to the base station. In some such embodiments, Y corresponds to a sharing percentage provided by the base station in the measurement object configuration. In some such embodiments, Y corresponds to a sharing percentage that is hardcoded to the UE.

In some embodiments, the method 700 further includes identifying the Y SMTCs from the plurality of SMTCs. In some such embodiments, the Y SMTCs are identified based on signaling from the base station. In some such embodiments, the method 700 further includes sending, to the base station, an identification of the Y SMTCs. In some such embodiments, the Y SMTCs are identified according to a use of a sharing percentage within a round robin scheme.

Embodiments contemplated herein include an apparatus comprising means to perform one or more elements of the method 700. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 700. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 1002 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

In some cases, it may be that a UE is configured to determine how many configurations as provided in a MO for a carrier used by one or more NTN neighbor cells that it will actually use to actually perform SSB measurement(s) on that carrier for those one or more NTN neighbor cells. The UE may make this determination as among SMTC of the MO that indicate for the same periodicity but for unique offsets. In such circumstances where measurement gaps (e.g., network-configured durations or periods where the UE does not use its serving cell on either UL or DL) are configured at the UE, the overall process may occur in view of a number and/or nature of one or more measurement gaps configured to the UE. For example, a UE may receive (e.g., from a base station) a number X of SMTC configurations that each indicate a (same) given periodicity and a different offset. The number X of the SMTC configurations received in the MO (e.g., that were configured by the network) may be affected by a network determination about the number and/or nature of the measurement gaps that have been configured to the UE. Then, the UE may determine a number Y of the SMTC to actually use to measure SSB(s) on the corresponding carrier (where Y≤X)

Such determinations and their corresponding applications may apply for cases where the UE performs either intra-frequency measurement or inter-frequency measurement on a neighbor cell, and when the measurement gaps have been provided to/configured for at the UE for the time of the corresponding measurements.

In a first case, the network may determine that the UE has been configured with Z measurement gaps. Then, based on a determination that the UE will use one SMTC per measurement gap, number of SMTCs X that is sent in the MO to the UE may be constrained by Z (e.g., X≤Z).

In some instances of the first case, the subsequent determination of Y by the UE may be further limited by a concurrent measurement gap use capability of the UE, which may describe a number 21 of measurement gaps the UE is capable of using during one period of the periodicity indicated by the SMTCs (e.g., Z₁≤Z). In such a case where Z₁<Z and one SMTC is used per measurement gap, the determination of Y will be further limited by Z₁ (e.g., Y≤Z₁).

In a second case, the network may determine that the UE has been configured with Z measurement gaps. The network may further determine that the one or more of the measurement gaps may be large enough to accommodate more than one SMTC. In such a case, the number of SMTCs X that is sent in the MO to the UE may be greater than Z (e.g., X>Z), thereby enabling the UE to potentially select a number Y of SMTCs that is greater than the number of measurement gaps Z, in the event that a measurement gap use capability allows for this.

In some instances of the second case, the subsequent determination of Y by the UE may be limited by a concurrent measurement gap use capability of the UE, which may describe a number 21 measurement gaps the UE is capable of using during one period of the periodicity indicated by the SMTCs (e.g., Z₁≤Z). In such a case where Z₁<Z, but where multiple SMTCs may be used in one or more measurement gaps, the determination of Y will be further limited to the number of SMTCs that can “fit” into 21 measurement gaps (where the UE may select the most advantageous (largest) measurement gaps to be the 21 measurement gaps used). Note that it is contemplated that even in the case where only 21 measurement gaps are used (but where one or more of these can “fit” multiple SMTCs), the number of SMTCs used Y could still meet or even exceed the number of measurement gaps Z.

In a third case, the network may determine that the UE has been configured with Z measurement gaps. Further, the network may determine that the UE has an SMTC capability of being configured for up to M SMTCs. The network may then send number of SMTCs X in a MO to the UE, where X is constrained by the minimum of Z and M (e.g., X<min (Z, M)

In some instances of the third case, the subsequent determination of Y by the UE may be limited by a concurrent measurement gap use capability of the UE, which may describe a number Z₁ of measurement gaps the UE is capable of using during one period of the periodicity indicated by the SMTCs (e.g., Z₁≤Z). It may also be that the determination of Y by the UE may be limited (e.g., alternatively/additionally) by a concurrent (or parallel) SMTC capability M₁ that describes the number of SMTCs that the UE is capable of using concurrently (e.g., in parallel) during one period. The UE may then select Y SMTCs where Y is constrained by the minimum of Z₁ and M₁ (e.g., Y≤min (Z₁, M₁)).

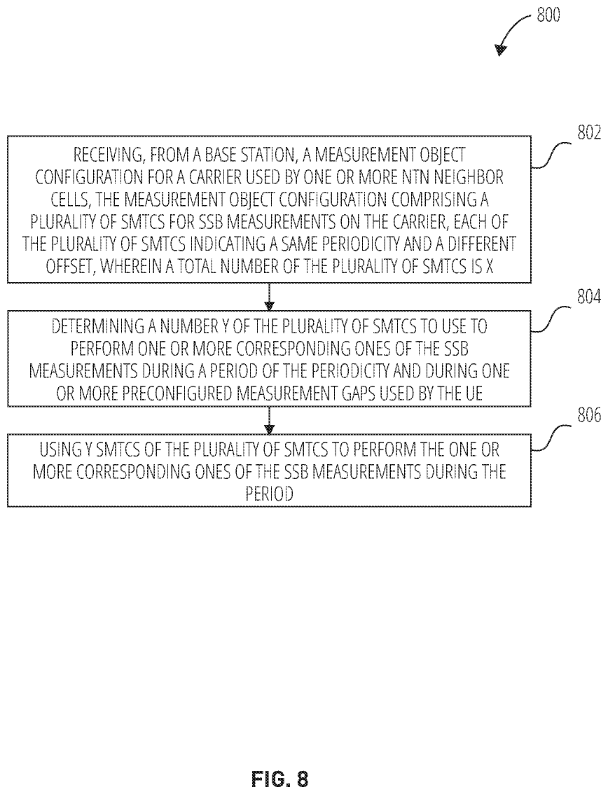

FIG. 8 illustrates a method 800 of a UE, according to an embodiment. The method 800 includes receiving 802, from a base station, a measurement object configuration for a carrier used by one or more NTN neighbor cells, the measurement object configuration comprising a plurality of SMTCs for SSB measurements on the carrier, each of the plurality of SMTCs indicating a same periodicity and a different offset, wherein a total number of the plurality of SMTCs is X.

The method 800 further includes determining 804 a number Y of the plurality of SMTCs to use to perform one or more corresponding ones of the SSB measurements during a period of the periodicity and during one or more preconfigured measurement gaps used by the UE.

The method 800 further includes using 806 Y SMTCs of the plurality of SMTCs to perform the one or more corresponding ones of the SSB measurements during the period.

In some embodiments of the method 800, X is less than or equal to a total number of the one or more preconfigured measurement gaps. In some such embodiments, the UE determines Y based on a concurrent measurement gap use capability of the UE.

In some embodiments of the method 800, at least one of the one or more preconfigured measurement gaps is of a length that is sufficient for multiple SMTCs of the plurality of SMTCs, and X is greater than a total number of the one or more preconfigured measurement gaps. In some of such embodiments, the UE determines Y based on a concurrent measurement gap use capability of the UE.

In some embodiments of the method 800, X is less than or equal to a minimum of a total number of the one or more preconfigured measurement gaps and an SMTC capability of the UE. In some such embodiments, the UE determines the number Y of the plurality of SMTCs to use based on a minimum of a concurrent measurement gap use capability of the UE and a concurrent SMTC capability of the UE.

Embodiments contemplated herein include an apparatus comprising means to perform one or more elements of the method 800. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 800. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 1002 that is a UE, as described herein).

Embodiments contemplated herein include a signal as described in or related to one or more elements of the method 800.

Embodiments contemplated herein include a computer program or computer program product comprising instructions, wherein execution of the program by a processor is to cause the processor to carry out one or more elements of the method 800. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications and other 3GPP documents.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as terrestrial base station 912, the terrestrial base station 914 the satellite base station 936 and the satellite base station 938) and/or other entities (e.g., the satellite 942, which may not have base station functionality) that enable the connection 908 and connection 910. One or more satellite gateways 934 may integrate the satellite base station 936, satellite base station 938, and/or the satellite 942 into the RAN 906, in the manners (and with the appropriate elements) described in relation to the NTN architecture 100 of FIG. 1 and the NTN architecture 200 of FIG. 2.

In this example, the connection 908 and connection 910 are air interfaces to enable such communicative coupling, and may be consistent with RAT(s) used by the RAN 906, such as, for example, an LTE and/or NR. It is contemplated that the connection 908 and connection 910 may include, in some embodiments, service links between their respective UE 902, UE 904 and one or more of the satellite base station 936, the satellite base station 938, and the satellite 942.

In some embodiments, the UE 902 and UE 904 may also directly exchange communication data via a sidelink interface 916.

The UE 904 is shown to be configured to access an access point (shown as AP 918) via connection 920. By way of example, the connection 920 can comprise a local wireless connection, such as a connection consistent with any IEEE 902.11 protocol, wherein the AP 918 may comprise a Wi-Fi router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other, with the terrestrial base station 912, the terrestrial base station 914, the satellite base station 936, the satellite base station 938, and/or the satellite 942 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the terrestrial base station 912, terrestrial base station 914, the satellite base station 936 and/or the satellite base station 938 may be implemented as one or more software entities running on server computers as part of a virtual network.

In addition, or in other embodiments, the terrestrial base station 912 or terrestrial base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. It is contemplated than an inter-satellite link (ISL) may carry the X2 interface between in the case of two satellite base stations.

In embodiments where the wireless communication system 900 is an NR system (e.g., when CN 924 is a 5GC), the interface 922 may be an Xn interface. An Xn interface is defined between two or more base stations that connect to 5GC (e.g., CN 924). For example, the Xn interface may be between two or more gNBs that connect to 5GC, a gNB connecting to 5GC and an eNB, between two eNBs connecting to 5GC, and/or two or more satellite base stations via an ISL (as in, e.g., the interface 940 between the satellite base station 936 and the satellite base station 938).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium). For example, the components of the CN 924 may be implemented in one or more processors and/or one or more associated memories.

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the terrestrial base station 912, terrestrial base station 914, the satellite base station 936, or the interface 940 and a serving gateway (S-GW), and the S1-MME interface, which is a signaling interface between the terrestrial base station 912, the terrestrial base station 914 the satellite base station 936, or the interface 940 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the terrestrial base station 912, terrestrial base station 914, satellite base station 936, or satellite base station 938 and a user plane function (UPF), and the S1 control plane (NG-C) interface, which is a signaling interface between the terrestrial base station 912, terrestrial base station 914 satellite base station 936, or satellite base station 938 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

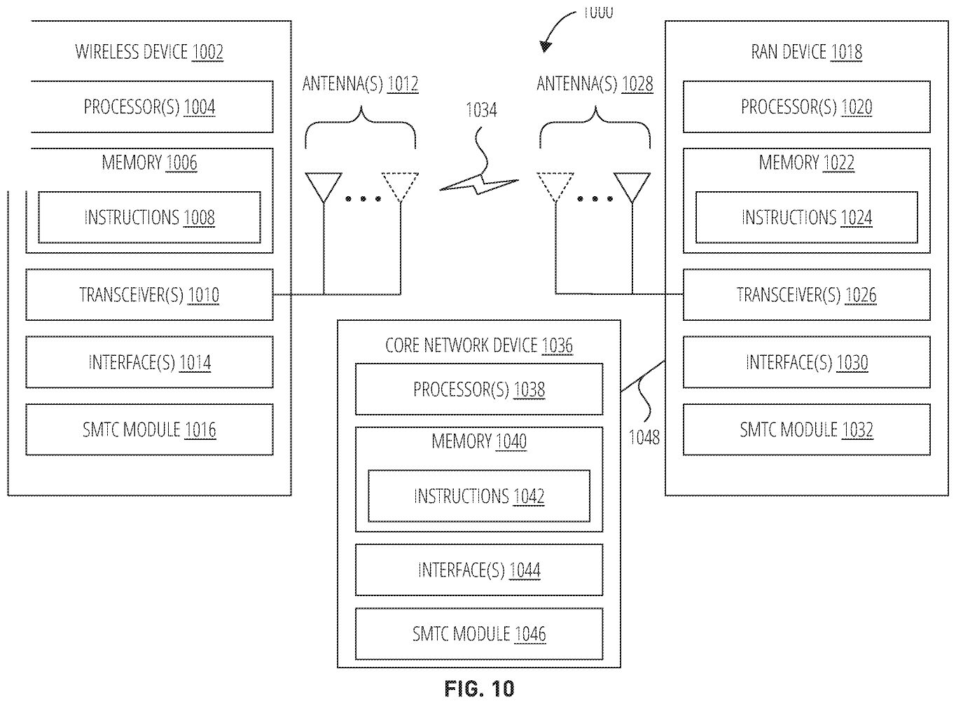

FIG. 10 illustrates a system 1000 for performing signaling 1034 between a wireless device 1002 and a RAN device 1018 connected to a core network of a CN device 1036, according to embodiments disclosed herein. The system 1000 may be a portion of a wireless communications system as herein described. The wireless device 1002 may be, for example, a UE of a wireless communication system. The RAN device 1018 may be, for example, a base station (e.g., an eNB or a gNB) of a wireless communication system that is a terrestrial base station or a satellite base station. The CN device 1036 may be one or more devices making up a CN, as described herein.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1034) to and/or from the wireless device 1002 with other devices (e.g., the RAN device 1018) according to corresponding RATs. In some embodiments, the antenna(s) 1012 may include a moving parabolic antenna, an omni-directional phased-array antenna, or some other antenna suitable for communication with a satellite, (e.g., as described above in relation to the UE 110 of FIG. 1 and the UE 208 of FIG. 2).

For a RAN device 1018 that is a terrestrial base station, the network device signaling 1034 may occur on a feeder link between the wireless device 1002 and a satellite and a service link between the satellite and the RAN device 1018 (e.g., as described in relation to FIG. 1). For a RAN device 1018 that is a satellite base station, the signaling 1034 may occur on a feeder link between the wireless device 1002 and the RAN device 1018 (e.g., as described in relation to FIG. 2).

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1010/antenna(s) 1012 already described) that allow for communication between the UE and other devices and may operate according to known protocols (e.g., Wi-Fi*, Bluetooth®, and the like).

The wireless device 1002 may include an SMTC module 1016. The SMTC module 1016 may be implemented via hardware, software, or combinations thereof. For example, the SMTC module 1016 may be implemented as a processor, circuit, and/or instructions 1008 stored in the memory 1006 and executed by the processor(s) 1004. In some examples, the SMTC module 1016 may be integrated within the processor(s) 1004 and/or the transceiver(s) 1010. For example, the SMTC module 1016 may be implemented by a combination of software components (e.g., executed by a DSP or a general processor) and hardware components (e.g., logic gates and circuitry) within the processor(s) 1004 or the transceiver(s) 1010.

The SMTC module 1016 may be used for various aspects of the present disclosure, for example, aspects of FIG. 3 through FIG. 8. The SMTC module 1016 is configured to, for example, use an MO received from the base station having multiple SMTCs indicating a same periodicity and different offsets as disclosed herein, and/or to use of scheduling restrictions by the UE based on NTN characteristics of one or more of a serving cell and a neighbor cell to be measured.

The RAN device 1018 may include one or more processor(s) 1020. The processor(s) 1020 may execute instructions such that various operations of the RAN device 1018 are performed, as described herein. The processor(s) 1004 may include one or more baseband processors implemented using, for example, a CPU, a DSP, an ASIC, a controller, an FPGA device, another hardware device, a firmware device, or any combination thereof configured to perform the operations described herein.

The RAN device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The RAN device 1018 may include one or more transceiver(s) 1026 that may include RF transmitter and/or receiver circuitry that use the antenna(s) 1028 of the RAN device 1018 to facilitate signaling (e.g., the signaling 1034) to and/or from the RAN device 1018 with other devices (e.g., the wireless device 1002) according to corresponding RATs.

The RAN device 1018 may include one or more antenna(s) 1028 (e.g., one, two, four, or more). In embodiments having multiple antenna(s) 1028, the RAN device 1018 may perform MIMO, digital beamforming, analog beamforming, beam steering, etc., as has been described.

For a RAN device 1018 that is a terrestrial base station, one or more of the transceiver(s) 1026 and/or the antenna(s) 1028 may instead be present on a satellite gateway associated with the base station (e.g., as shown in reference to the terrestrial base station 104 and the satellite gateway 106 of FIG. 1). For a RAN device 1018 that is a satellite base station, the transceiver(s) 1026 and/or the antenna(s) 1028 may be present on the satellite, and one or more of those antenna(s) 1028 may be antenna(s) appropriate for satellite communication (such as a moving parabolic antenna, an omni-directional phased-array antenna, etc.)

The RAN device 1018 may include one or more interface(s) 1030. The interface(s) 1030 may be used to provide input to or output from the RAN device 1018. For example, a RAN device 1018 that is a base station may include interface(s) 1030 made up of transmitters, receivers, and other circuitry (e.g., other than the transceiver(s) 1026/antenna(s) 1028 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 1018 may include an SMTC module 1032. The SMTC module 1032 may be implemented via hardware, software, or combinations thereof. For example, the SMTC module 1032 may be implemented as a processor, circuit, and/or instructions 1024 stored in the memory 1022 and executed by the processor(s) 1020. In some examples, the SMTC module 1032 may be integrated within the processor(s) 1020 and/or the transceiver(s) 1026. For example, the SMTC module 1032 may be implemented by a combination of software components (e.g., executed by a DSP or a general processor) and hardware components (e.g., logic gates and circuitry) within the processor(s) 1020 or the transceiver(s) 1026.

The SMTC module 1032 may be used for various aspects of the present disclosure, for example, aspects of FIG. 3 through FIG. 8. The SMTC module 1032 is configured to, for example, configure an MO to send to a UE having multiple SMTCs indicating a same periodicity and different offsets as disclosed herein, and/or to transmit or cause to be transmitted such an MO to the UE.

The RAN device 1018 may communicate with the CN device 1036 via the interface 1048, which may be analogous to the interface 928 of FIG. 9 (e.g., may be an S1 and/or NG interface, either of which may be split into user plane and control plane parts).

The CN device 1036 may include one or more processor(s) 1038. The processor(s) 1038 may execute instructions such that various operations of the CN device 1036 are performed, as described herein. The processor(s) 1038 may include one or more baseband processors implemented using, for example, a CPU, a DSP, an ASIC, a controller, an FPGA device, another hardware device, a firmware device, or any combination thereof configured to perform the operations described herein.

The CN device 1036 may include a memory 1040. The memory 1040 may be a non-transitory computer-readable storage medium that stores instructions 1042 (which may include, for example, the instructions being executed by the processor(s) 1038). The instructions 1042 may also be referred to as program code or a computer program. The memory 1040 may also store data used by, and results computed by, the processor(s) 1038.

The CN device 1036 may include one or more interface(s) 1044. The interface(s) 1044 may be used to provide input to or output from the CN device 1036. For example, a CN device 1036 may include interface(s) 1030 made up of transmitters, receivers, and other circuitry that enables the CN device 1036 to communicate with other equipment in the CN, and/or that enables the CN device 1036 to communicate with external networks, computers, databases, and the like for purposes of operations, administration, and maintenance of the CN device 1036 or other equipment operably connected thereto.

The CN device 1036 may include an SMTC module 1046. The SMTC module 1046 may be implemented via hardware, software, or combinations thereof. For example, the SMTC module 1046 may be implemented as a processor, circuit, and/or instructions 1042 stored in the memory 1040 and executed by the processor(s) 1038. In some examples, the SMTC module 1046 may be integrated within the processor(s) 1038. For example, the SMTC module 1046 may be implemented by a combination of software components (e.g., executed by a DSP or a general processor) and hardware components (e.g., logic gates and circuitry) within the processor(s) 1038.

The SMTC module 1046 may be used for various aspects of the present disclosure, for example, aspects of FIG. 3 through FIG. 8. The SMTC module 1046 is configured to, for example, configure an MO to send to a UE having multiple SMTCs indicating a same periodicity and different offsets as disclosed herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a base station, a measurement object configuration for a carrier used by one or more non-terrestrial network (NTN) intra-frequency neighbor cells of the UE, the measurement object configuration comprising a plurality of synchronization signal block (SSB)-based measurement timing configurations (SMTCs) for SSB measurements on the carrier, wherein a first of the plurality of SMTCs indicates a first periodicity and a first offset and a second of the plurality of SMTCs indicates the first periodicity and a second offset; and
performing one of the SSB measurements on one of the one or more NTN intra-frequency neighbor cells according to one of the plurality of SMTCs.

2. The method of claim 1, wherein the plurality of SMTCs are represented in the measurement object using a first SMTC set and a second SMTC set, wherein the first SMTC set comprises first one or more SMTCs of the plurality of SMTCs indicating the first periodicity, and wherein the second SMTC set comprises second one or more SMTCs of the plurality of SMTCs indicating a second periodicity.

3. The method of claim 2, wherein each of the first one or more SMTCs indicates for a use of a unique offset as among the first one or more SMTCs.

4. The method of claim 2, wherein a number of the first one or more SMTCs in the first SMTC set is limited by a first upper bound.

5. The method of claim 4, wherein a number of second one or more SMTCs in the second SMTC set is limited by a second upper bound.

6. The method of claim 1, wherein the measurement object configuration comprises a single SMTC set including the plurality of SMTCs, and wherein each of the plurality of SMTCs indicates a same periodicity.

7. A method of a user equipment (UE), comprising:
determining first one or more non-terrestrial network (NTN) characteristics of a serving cell of the UE;
determining second one or more NTN characteristics of a neighbor cell of the UE on which the UE is to perform a measurement; and
applying, based on the first one or more first NTN characteristics and the second NTN characteristics, a scheduling restriction for the UE, whereby no transmissions between the UE and a base station of the serving cell are used at the UE during a period corresponding to the measurement by the UE of the neighbor cell.

8. The method of claim 7, wherein the first one or more NTN characteristics of the serving cell include that the serving cell is an NTN cell, and wherein the UE applies the scheduling restriction because the serving cell is an NTN cell.

9. The method of claim 7, wherein the second one or more NTN characteristics of the neighbor cell include that the neighbor cell is an NTN cell, and wherein the UE applies the scheduling restriction because the neighbor cell is an NTN cell.

10. The method of claim 7, wherein:
the first one or more NTN characteristics of the serving cell comprise that the serving cell is provided by a first satellite that is in a first of a geosynchronous earth orbit (GEO) and a low earth orbit (LEO);
the second one or more NTN characteristics of the neighbor cell comprise that the neighbor cell is provided by a second satellite that is in a second of the GEO and the LEO; and
the UE applies the scheduling restriction based on a determination that the first satellite and the second satellite are in different types of orbits.

11. The method of claim 7, wherein:
the first one or more NTN characteristics of the serving cell include that the serving cell is provided by a first satellite that is moving in a first direction at a first speed;
the second one or more NTN characteristics of the neighbor cell include that the neighbor cell is provided by a second satellite that is moving in a second direction at a second speed; and
the UE applies the scheduling restriction based on one or more of a first comparison of the first direction to the second direction and a second comparison of the first speed to the second speed.

12. The method of claim 11, wherein the UE applies the scheduling restriction because the first direction is different than the second direction.

13. The method of claim 11, wherein the UE applies the scheduling restriction because the first speed is different than the second speed.

14. The method of claim 7, wherein the UE supports mixed numerology.

15. The method of claim 7, wherein a first numerology of the serving cell is the same as a second numerology of the neighbor cell.

16. The method of claim 7, wherein the measurement by the UE of the neighbor cell comprises a synchronization signal block (SSB) measurement of the neighbor cell according to an SSB-based measurement timing configuration (SMTC) at the UE corresponding to the neighbor cell, and wherein the period comprises a duration of the SSB measurement.

17. The method of claim 7, wherein the measurement by the UE of the neighbor cell comprises a reference signal measurement of the neighbor cell, and wherein the period comprises a first duration of a first symbol prior to the reference signal measurement, a second duration corresponding to the reference signal measurement, and a third duration of a second symbol following the reference signal measurement.

18. The method of claim 7, wherein the UE has not been configured with a measurement gap for the measurement.

19. A method of a user equipment (UE), comprising:
receiving, from a base station, a measurement object configuration for a carrier used by one or more non-terrestrial network (NTN) neighbor cells, the measurement object configuration comprising a plurality of synchronization signal block (SSB)-based measurement timing configurations (SMTCs) for SSB measurements on the carrier, each of the plurality of SMTCs indicating a same periodicity and a different offset, wherein a total number of the plurality of SMTCs is A;
determining a number Y of the plurality of SMTCs to use to perform one or more corresponding ones of the SSB measurements during a period of the periodicity; and
using Y SMTCs of the plurality of SMTCs to perform the one or more corresponding ones of the SSB measurements during the period.

20. The method of claim 19, wherein the UE supports mixed numerology.

21-39. (canceled)
